(19) United States
(12) Patent Application Publication
(10) Pub. No.: US 2006/0194169 A1
(43) Pub. Date: Aug. 31, 2006

(54) Dental implant system

(76) Inventor: Ho Chich Chung, Cishan Township (TW)

Correspondence Address: GENUS LAW GROUP;LOWE HAUPTMAN & BERNER, LLP, 1700 DIAGONAL ROAD, SUITE 300, ALEXANDRIA, VA, 22314, US

(21) Appl. No.: 11/067,995

(22) Filed: Feb. 28, 2005

(51) Int. Cl. A61C 8/00

(52) U.S. Cl. 433/173

(57) ABSTRACT

The present invention of the dental implants pays more attention to the horizontal force that is usually ignored by other systems. By the design of generally vertical plate-like projection(s) and clearances, the implant should deal the force from occlusion more correctly.

### BACKGROUND OF THE INVENTION

1. FIELD OF THE INVENTION

This is a dental implant which is generally cylindrical and is not tapered.

2. DESCRIPTION OF THE RELATED ART

### BACKGROUND ART

The occlusal force can be divided into vertical force and horizontal force. The vertical force for the implant is the compression force at the bottom and the shearing force at the lateral. The horizontal force is a tipping force for the implant.

Since the horizontal force toward the proximal side is co-bolstered by the adjacent teeth (or implants), such force is less detrimental to the alveolar bone. The dental implant catches the bone to resist the occlusal force. Therefore, to have implants catch enough alveolar bone for the occlusal force, yet keep the alveolar bone from being destroyed is the basic and most important consideration for dental implant design.

Since the advent of titanium dental implant, many dental implants have the shape of natural root lingered. But as a matter of fact, the supporting mechanisms of the natural tooth and that of the implant are not the same. The natural tooth is suspended in the bone by the ligaments, the implant is “fixed” to the bone. Mimicking the morphology of the root of the tooth does not make sense. Tapering of the implant would reduce the capability to resist the vertical force and the horizontal force. And as is seen clinically, the deeper portion of alveolar bone always has ample space for the implant. Another drawback for many contemporary implants is the threads or fins. The threads or fins are basically horizontal projection(s) from the cylinder. The horizontal projection(s) catch bone in such manners that they are significantly less equipped for horizontal forces than for vertical forces. This may explain why the successful rate of implant in the maxilla is always lower than that in the mandible. The implants in the maxilla receive more horizontal force than those in the mandible.

Bicon (U.S. Pat. No. 4,738,623) FIG. 1a, a dental implant system considered by many dentists one of the best implant systems, also has the disadvantages mentioned above. Like other implant, the entrance to the bone is the most vulnerable. Bicon (FIG. 1a) deals with the problem seriously. According to it's manual, the Bicon's (FIG. 1a) implant is implanted 1 mm˜2 mm below the alveolar crest. Later, some of the bone is removed, and the abutment and crown is connected to the implant. But as is clinically observed, in the long run the bone would retreat to the shoulder of Bicon's implant (FIG. 1a). Although the material of the implant and that of the abutment post are the same, the abutment post doesn't get osseointegrated. Maybe there is micro-rotation of the abutment post. An un-osseointegrated post in the bone is a highway for the hostile bacteria In some cases, the bony deteriorations continued, and the implant exposures were inevitable. The exposures were often on the horizontal-force-bearing side. Such exposure would embarrass the patient and leave an ordeal for the dentist.

### SUMMARY OF THE INVENTION

The present invention of the dental implants pays more attention to the horizontal force that is usually ignored by the other systems. By the design of proximal plate-like projection(s) and clearances on buccal and lingual sides, the implant may deal with the force from occlusion more correctly.

The proximal plate-like projection(s) catch more bone for the horizontal force and escape from most of the vertical force. The plate-like projection(s) arise from the cylinder toward distal or mesial direction. On the buccal and lingual sides at the level of the plate-like projection(s), there are no projection(s). Because the buccal and lingual bone plates are always thin and are also the weak points in dental implantology, the plates had better not to bear too much force. Continuing with the neck, the clearances and the neck provide more space for the bony plates and carry less force to the plates. The implant provides intact space for the thin plates that are not disturbed by any projection, and would help to meet esthetic demand because the chance of neck exposure is reduced. The implant effectively deals with the horizontal force by the plate-like projection(s) which are surrounded by ample bony structure.

The neck had better to be as narrow as possible if it's mechanically approved. With such design the rim on the neck would be narrow. The rim toward the buccal side is trimmed to simulate the curvature of buccal gingival. The trimming begins from proximal sides downwardly to the buccal side. The trimming would allow the surgeon not to bury the implant deep in the bone without worrying the exposure of dental implant on the buccal side. And the trimming is likely to match the asymmetrically resorbed ridge.

The bottom is dimpled. The bottom receives a lot of vertical force. The dimple disperses the pressure.

### BRIEF DESCRIPTION OF THE DRAWINGS

FIG. 1a is the prior art after healing and the dot line means the later retreated condition.

FIG. 1b is the embodiment of the present invention (TypeA).

FIG. 2a is the proximal view of the embodiment for the TypeA invention.

FIG. 2b is the buccal view of the embodiment for the TypeA invention.

FIG. 2c is the downward perspective view of the embodiment for the TypeA invention.

FIG. 2d is the top view of the embodiment for the TypeA invention.

FIG. 2e is the upward perspective view of the embodiment for the TypeA invention.

FIG. 3a is the proximal view of the embodiment for the TypeB invention.

FIG. 3b is the buccal view of the embodiment for the TypeB invention.

FIG. 3c is the downward perspective view of the embodiment for the TypeB invention.

FIG. 3d is the top view of the embodiment for the TypeB invention.

FIG. 3e is the upward perspective view of the embodiment for the TypeB invention.

FIG. 4 is the proximal view of the trimmed neck.

FIG. 5 is the top view of the different arrangements of the plate-like projection(s).

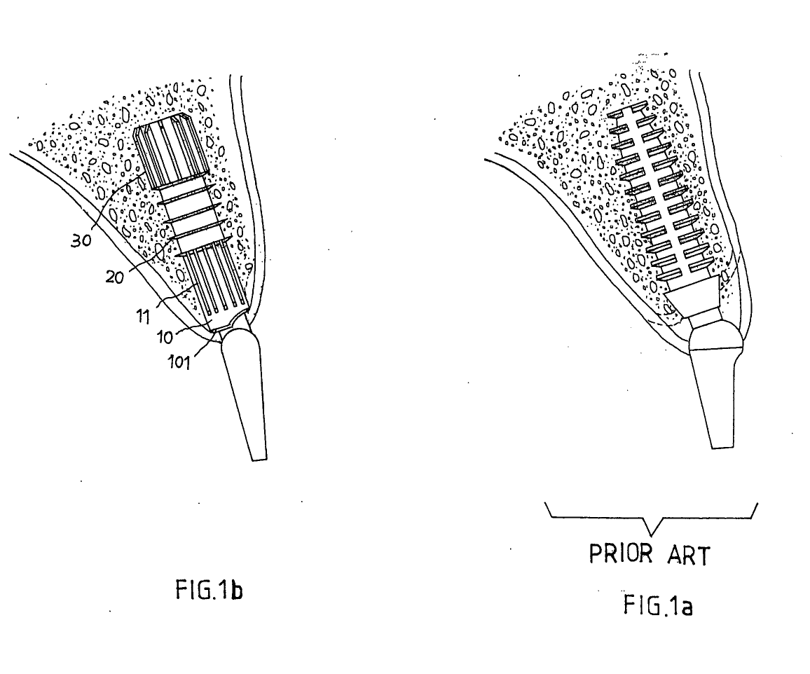

### DISCLOSURE

Before the description of the implant, some terminology must be clearly defined.

The term “lower” is not related to gravity, it means in the deeper bone, and “upper” means it's proximal to the gingival or crown. And “buccal” means buccal or facial, “lingual” means lingual or palatal. “Vertical” means in the direction along with the longitudinal axis of the implant, “horizontal” means in the direction that is perpendicular to “vertical”.

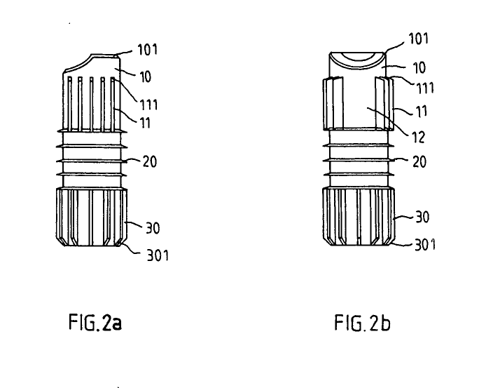

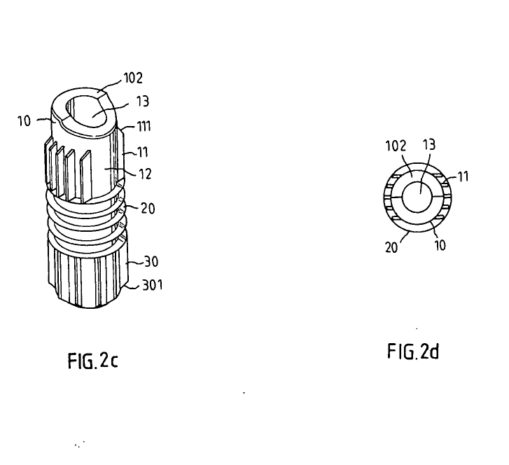

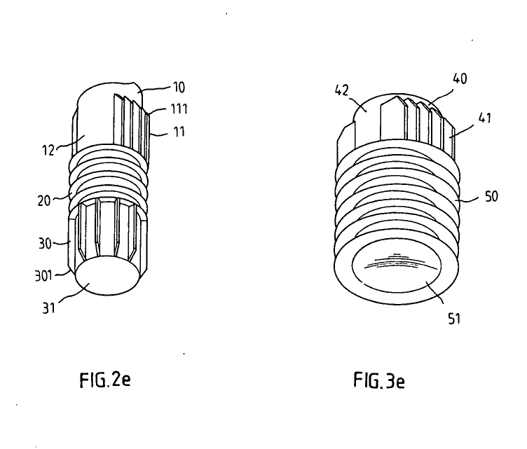

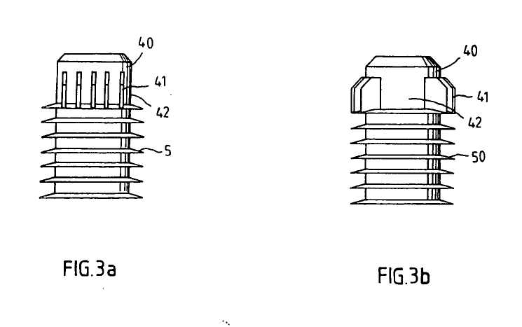

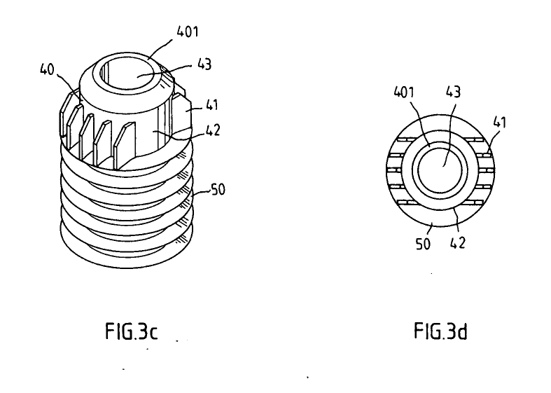

The implant that would receive more horizontal force than vertical force (from occlusion) is named TypeA implant (FIGS. 2a,b,c,d,e). The implant that would receive more vertical force is named TypeB implant (FIGS. 3a,b,c,d,e). Generally the TypeA implant would be for the maxillary anteriors.

The present invention is generally a cylindrical and un-tapered implant that is later to connect an abutment for the prosthesis.

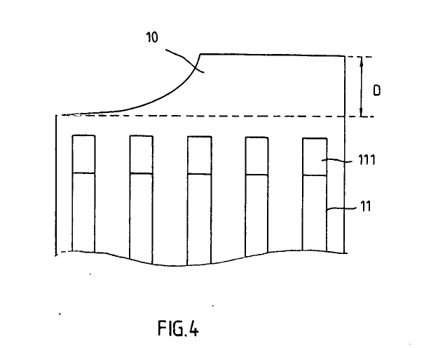

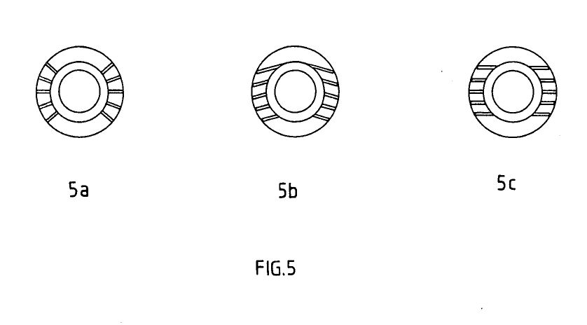

Beside the well 13 for the connection of the abutment, the TypeA implant (FIGS. 2a,b,c,d,e) from upper to lower comprises (1) the neck 10 (2) the upper proximal plate-like projection(s) 11 and clearances 12 on buccal and lingual sides (3) the 360° fins 20 (4) the lower plate-like projection(s) 30 (5) the bottom 31.
(1) The neck: The neck 10 is a 1.5 mm˜3.0 mm cylinder-like design with some rounding at the edge 101, which is 0˜5° inward and upward to the implant axis. The neck had better be as narrow as possible if it's mechanically approved. With such design the rim on the neck would be narrow The rim 102 toward the buccal side is trimmed to simulate the curvature of buccal gingival. The trimming (FIG. 4) begins from proximal sides downwardly to the buccal side, and is preferably concave. The implant is preferably implanted at the level of bony crest. The trimming would allow the surgeon not to bury the implant deep in the bone without worrying the exposure of dental implant on the buccal side. And the trimming is preferably to match the asymmetrically resorbed ridge.
(2) The upper plate-like projection(s) 11 and the clearances 12: Following the neck 10 are the upper proximal plate-like projection(s) 11 and the buccal and lingual clearances 12. The plate-like projection(s) preferably are comprehensively pruned at the upper edge 111. The plate-like projection(s) arise from the cylinder at roughly 90° angle to the tangent of cylinder FIG. 5a or at angles that are easily manufactured and still can catch a lot of bone for the horizontal force, shown as FIG. 5b and FIG. 5c. The plate-like projection(s) would preferably not extend beyond the tangent line of buccal or lingual border. The plate-like projection(s) are good at catching the bone for the horizontal force and escape from the vertical force. Such design can prevent from overloading. On the buccal and lingual sides at the level of the plate-like projection(s), there are no projection(s). Because the buccal and lingual bone plates are always thin and are also the weak points in dental implantology, the plates had better not to bear too much force. Continuing with the neck, the clearances 12 and the neck 10 provide more space for the bony plates and carry less force to the plates. The implant effectively deals with the horizontal force by the plate-like projection(s) 11 which are surrounded by ample bony structure. Thus the chance of bony deterioration is reduced. The portion of the implant with the upper plate-like projection's is suggested to be about 2/5˜1/4 of the whole implant. Because the horizontal force is least felt in the middle portion, the plate-like projection(s) do not appear in the portion. The ideal angel for the plate-like projection to longitudinal axis of the implant is 0°, but it could be 0˜45°.
(3) The fins 20: Next to the plate-like projection(s) 11 are the fins 20 horizontally and outwardly projected from the cylinder. The fins 20 are not tapered. The portion of the implant with the fins 20 is suggested to be about 1/2˜1/5 of the implant.
(4) Between the bottom 31 and the fins 20, the lower plate-like projection(s) 30 arise from the cylinder circumferentially. The length of the lower plate-like projection(s) 30 may be 2/5˜1/4 of the implant. The angles are suggested to be perpendicular to the tangents of the cylinder. Near the bottom 31, the edges of the plate-like projection(s) 30 are pruned to match the bottom of the bony socket; that is, to match the shape of the drill.
(5) The bottom 31: The bottom 31 is flat.
(6) The well 13: The well 13 is going to be connected to the abutment and has an opening at the top of the implant.

The TypeB implant (FIGS. 3a,b,c,d,e) comprises (1) the neck 40 (2) proximal plate-like projection(s) 41 and clearances 42 on buccal and lingual sides (3) the fins 50 (4) the bottom 51 (5) the well 43.
(1) The neck 40: It is similar to the previous description. But the neck 40 here is shorter and the rim is flat 401 or is less trimmed. The length of the neck 40 is between 0.5˜2 mm and the depth D of trimming is suggested to be 0.5-1.2 mm.
(2) The proximal plate-like projection(s) 41 and clearances 42 on buccal and lingual sides: they are also similar to the previous description. But the ratio differs. The length of plate-like projection(s) 41 or clearances 42 is 1/6˜2/5 the length of the whole implant.
(3) The fins 50: the fins 50 go down to the bottom 51 without shrinking their diameters.
(4) The bottom 51: the bottom 51 is dimpled. The bone at the bottom receives a lot of compression force. The dimple disperses the force. This is especially important for the short implant with large diameter. It needs the drill specially designed to shape the bottom of the bony socket if any length deeper is crucial.
(5) The well 43: it's similar to the previous description.

All the implants are suggested to be implanted into the bony socket with ease. Without pressuring the bone surrounding the implant, the formation of the callous bone will be encouraged. And it would be easier to place the implant in the bone with correct direction.

In describing the preferred embodiments of the invention which are illustrated in the drawings, specific terminology shall be resorted to for the sake of clarity. However, it is not intended that the invention be limited to the specific terms so selected and it is to be understood that each specific term includes all technical equivalents which operate in a similar manner to accomplish a similar purpose.

What is claimed is:

1. A generally cylindrical dental implant; the improvement comprising:
the proximal plate-like projection(s) that are projected from cylinder as such to provide sufficient resistance to horizontal force while leaving more room for bone plate(s).

2. The dental implant according to claim 1, wherein said proximal plate-like projection(s) are flat, curved or wavy.

3. The dental implant according to claim 2, wherein the surfaces of said proximal plate-like projection(s) are smooth , dimpled, roughed, troughed or porfotrated.

4. The dental implant according to claim 1, wherein the angle between said plate-like projection(s) to longitudinal axis of said implant is between 0°˜45°.

5. The dental implant according to claim 1, wherein the preferred angle of said plate-like projection(s) to longitudinal axis of said implant is 0°.

6. The dental implant according to claim 1, wherein said proximal plate-like projection(s) arise from said cylinder preferably at such an angle to fit the curvature of patient's alveolar bone.

7. The dental implant according to claim 1, wherein said proximal plate-like projection(s) arise from said cylinder such that they are generally parallel to each other on respective side.

8. The dental implant according to claim 1, wherein said proximal plate-like projection(s) are preferred not to exist on the middle portion.

9. The dental implant according to claim 1, wherein the upper edges of said plate-like projection(s) are pruned.

10. The dental implant according to claim 1, wherein said clearances on buccal and lingual sides are at the same level of said upper proximal plate-like projection(s).

11. The dental implant according to claim 10, wherein said clearances are dimpled.

12. The dental implant according to claim 1, wherein the portion with upper plate-like projection(s) in TypeA implant is about 1/4˜2/5 of the length of whole implant.

13. The dental implant according to claim 1, wherein the portion with proximal plate-like projection(s) in TypeB implant is about 1/6˜2/5 of the length of whole implant.

14. The dental implant according to claim 1, wherein said implant which would receive more horizontal force than vertical force has said lower circumferential plate-like projection(s) between said fins and said bottom.

15. The dental implant according to claim 14, wherein the portion with said lower plate-like projection(s) is about 2/5˜1/4 of the length of said implant.

16. The dental implant according to claim 1, wherein the height of said implant's neck is about 0.5 mm˜3.0 mm.

17. The dental implant according to claim 16, wherein said rim of said neck is trimmed.

18. The dental implant according to claim 17, wherein said neck is trimmed from proximal sides toward buccal side to make concave slopes which simulate the curvature of buccal gingiva.

19. The dental implant according to claim 18, wherein the depth of trimming is between 0.5 mm˜2 mm.

20. The dental implant according to claim 1, wherein said fins are next to said upper proximal plate-like projection(s) and clearances.

21. The dental implant according to claim 20, wherein the portion with said fins is about 5/6˜1/5 of the length of said implant.

22. The dental implant according to claim 1, wherein said bottom of said implant is dimpled.

23. The dental implant according to claim 1, wherein said implant is generally not tapered.
